(19) United States
(12) Patent Application Publication
(10) Pub. No.: US 2018/0336987 A1
(43) Pub. Date: Nov. 22, 2018

(54) COMMON MODE NOISE FILTER

(71) Applicant: Panasonic Intellectual Property Management Co., Ltd., Osaka (JP)

(72) Inventors: TAKUJI KAWASHIMA, Fukui (JP); YOSHIHARU OOMORI, Osaka (JP); YOICHI NAGASO, Fukui (JP); ATSUSHI SHINKAI, Fukui (JP)

(21) Appl. No.: 15/771,385

(22) PCT Filed: Sep. 26, 2017
(86) PCT No.: PCT/JP2017/034612

§ 371 Date: Apr. 26, 2018

(30) Foreign Application Priority Data
Oct. 5, 2016 (JP) 2016-196910

(51) Int. Cl. H01F 17/00

(52) U.S. Cl. CPC H01F 17/0013; H01F 2017/0073; H01F 2017/002

(57) ABSTRACT

A common mode noise filter includes a non-magnetic body and first to third coil conductors provided inside the non-magnetic body. The second coil conductor is provided in a downward direction from the first coil conductor. The third coil conductor is provided in the downward direction from the second coil conductor. The first and third coil conductors deviate in a direction perpendicular to the downward direction with respect to the second coil conductor. At least one of the first and third coil conductors overlaps the second coil conductor viewing from the direction perpendicular to the downward direction. This common mode noise filter allows these coil conductors to be magnetically coupled to each other with a preferable balance, thereby preventing degradation of differential signals.

### TECHNICAL FIELD

The present invention relates to a common mode noise filter for use in various electronic equipment, such as digital devices, audiovisual (AV) devices, and information communication terminals.

### BACKGROUND ART

As a digital data transmission standard for connecting a main IC to a display or a camera in a mobile computing device, a mipi (Mobile Industry Processor Interface) D-PHY standard has been adopted. In this standard, a system that transmits differential signals by using two transmission lines is used. In recent years, the resolution of cameras has been dramatically increased, and accordingly a higher-speed transmission system, that is, a system in which different voltages are transmitted to respective transmission lines from a transmitter by using three transmission lines, and the differences between the lines are obtained by a receiver to perform differential output has been put in practical use as a mipi C-PHY standard.

FIG. 10 is an exploded perspective view of conventional common mode noise filter 501. Common mode noise filter 501 includes a plurality of insulation layers 1a and three independent coils 2 to 4. Coil 2 includes coil conductors 2a and 2b that are connected to each other. Coil 3 includes coil conductors 3a and 3b that are connected to each other. Coil 4 includes coil conductors 4a and 4b that are connected to each other. Coils 2 to 4 are laminated in this order from the bottom. When a common mode noise is input to common mode noise filter 501, coils 2 to 4 mutually intensify produced magnetic fluxes and operate as an inductance to reduce the noise.

A conventional common mode noise filter similar to conventional common mode noise filter 501 is disclosed in, for example, PTL 1.

### CITATION LIST

### Patent Literature

PTL 1: Japanese Patent Laid-Open Publication No. 2003-77727

### SUMMARY

A common mode noise filter includes a non-magnetic body and first to third coil conductors provided inside the non-magnetic body. The second coil conductor is provided in a downward direction from the first coil conductor. The third coil conductor is provided in the downward direction from the second coil conductor. The first and third coil conductors are arranged deviate in a direction perpendicular to the downward direction with respect to the second coil conductor. At least one of the first and third coil conductor overlaps the second coil conductor viewing in the direction perpendicular to the downward direction.

In another common mode noise filter, the first, second, and third coil conductors do not overlap each other viewing in the direction perpendicular to the downward direction. An upper surface of the second coil conductor is flush with a lower surface of the first coil conductor. A lower surface of the second coil conductor is flush with an upper surface of the third coil conductor.

These common mode noise filters allow these coil conductors to be magnetically coupled to each other with a good balance, thereby preventing degradation of differential signals.

### BRIEF DESCRIPTION OF DRAWINGS

FIG. 1 is a cross-sectional view of a common mode noise filter according to Embodiment 1.

FIG. 2A is a top view of the common mode noise filter according to Embodiment 1.

FIG. 2B is a bottom view of the common mode noise filter according to Embodiment 1.

FIG. 2C is a circuit diagram of the common mode noise filter according to Embodiment 1.

FIG. 3 is an enlarged cross-sectional view of the common mode noise filter according to Embodiment 1.

FIG. 4 is an exploded perspective view of the common mode noise filter of a comparative example.

FIG. 5A is a cross-sectional view of another common mode noise filter according to Embodiment 1.

FIG. 5B is a top view of the common mode noise filter illustrated in FIG. 5A.

FIG. 6A is a cross-sectional view of still another common mode noise filter according to Embodiment 1.

FIG. 6B is a top view of the common mode noise filter illustrated in FIG. 6A.

FIG. 7 is an enlarged cross-sectional view of a further common mode noise filter according to Embodiment 1.

FIG. 8 is an enlarged cross-sectional view of a further common mode noise filter according to Embodiment 1.

FIG. 9 is an enlarged cross-sectional view of a common mode noise filter according to Exemplary Embodiment 2.

FIG. 10 is an exploded perspective view of a conventional common mode noise filter.

### DETAILED DESCRIPTION OF PREFERRED EMBODIMENTS

### Exemplary Embodiment 1

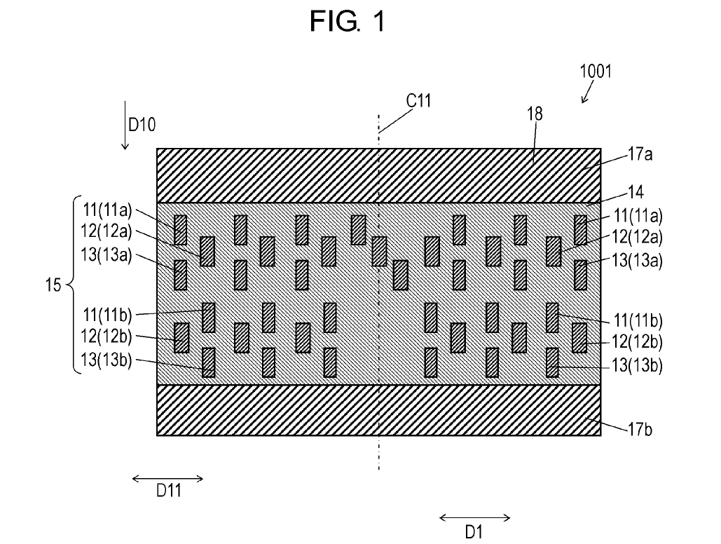

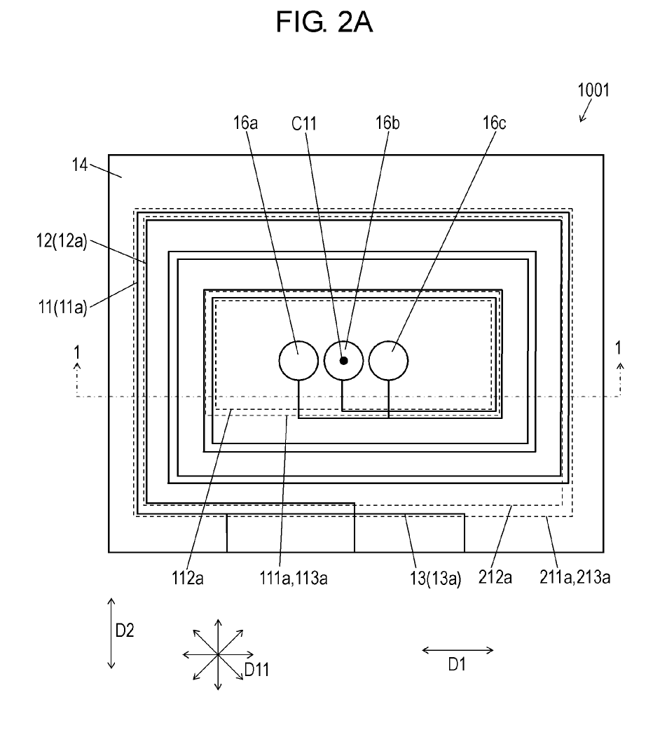

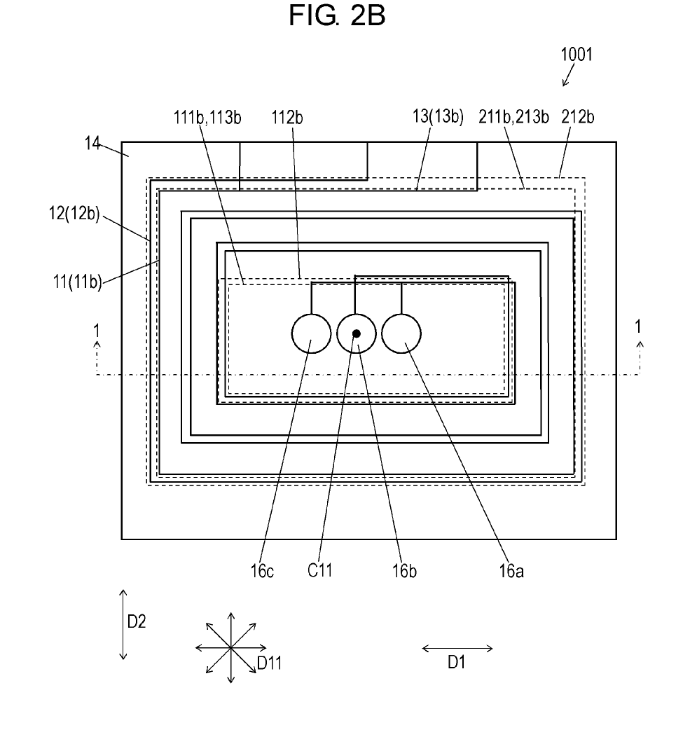

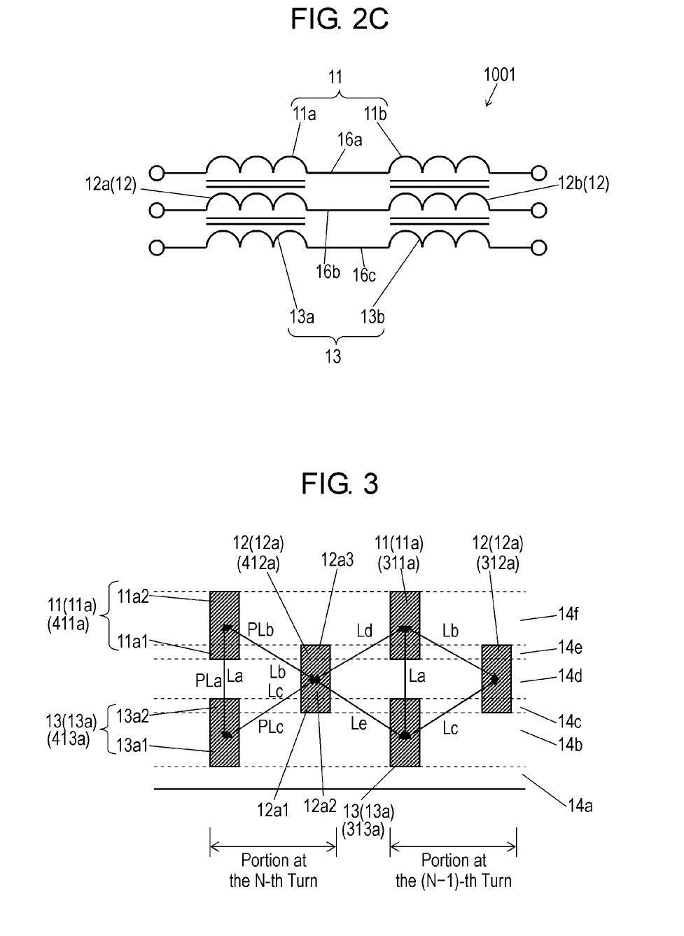

FIG. 1 is a cross-sectional view of common mode noise filter 1001 according to Exemplary Embodiment 1. FIG. 2A and FIG. 2B are a top view and a bottom view of common mode noise filter 1001, respectively. FIG. 1 shows a cross section of common mode noise filter 1001 along line 1-1 shown in FIG. 2A and FIG. 2B. FIG. 2C is a circuit diagram of common mode noise filter 1001.

Common mode noise filter 1001 includes non-magnetic body 14 and coil conductors 11a, 11b, 12a, 12b, 13a, and 13b provided inside non-magnetic body 14. Coil conductors 11a and 11b are electrically connected to each other to constitute coil 11. Coil conductors 12a and 12b are electrically connected to each other to constitute coil 12. Coil conductors 13a and 13b are electrically connected to each other to constitute coil 13. In accordance with Embodiment 1, coil conductors 11a and 11b are electrically connected in series to each other through via-conductor 16a to constitute coil 11. Coil conductors 12a and 12b are electrically connected in series to each other through via-conductor 16b to constitute coil 12. Coil conductors 13a and 13b are electrically connected in series to each other through via-conductor 16c to constitute coil 13. Coils 11, 12, and 13 are independent from each other.

Non-magnetic body 14 includes plural non-magnetic layers staked on one another. Coil conductors 11a to 13a and 11b to 13b are provided by spirally plating or printing the respective non-magnetic layers with conductive material, such as silver.

As illustrated in FIG. 2A, coil conductor 11a has a spiral shape with one or more turns from inner circumference 111a to outer circumference 211a. Coil conductor 12a has a spiral shape with one or more turns from inner circumference 112a to outer circumference 212a. Coil conductor 13a has a spiral shape with one or more turns from inner circumference 113a to outer circumference 213a. As illustrated in FIG. 2B, coil conductor 11b has a spiral shape with one or more turns from inner circumference 111b to outer circumference 211b. Coil conductor 12b has a spiral shape with one or more turns from inner circumference 112b to outer circumference 212b. Coil conductor 13b a spiral shape with one or more turns from inner circumference 113b to outer circumference 213b. In other words, each of coil conductors 11a to 13a and 11b to 13b has the spiral shape with M turns, where M is a number equal to or greater than one. Each of inner circumferences 111a to 113a and 111b to 113b and outer circumferences 211a to 213a and 211b to 213b has a rectangular shape with long sides extending in longitudinal direction D1 and short sides extending in lateral direction D2 perpendicular to longitudinal direction D1 and being shorter than the long sides. The conductors are the same in the width, pitch, and thickness of a spiral-shaped portion, that is, a main part excluding a portion used for, for example, wiring. Longitudinal direction D1 and lateral direction D2 are perpendicular to downward direction D10.

Coil conductor 11a constituting coil 11, coil conductor 12a constituting coil 12, coil conductor 13a constituting coil 13, coil conductor 11b constituting coil 11, coil conductor 12b constituting coil 12, and coil conductor 13b constituting coil 13 are disposed in this order from above to constitute laminated body 15. In other words, coil conductor 12a is provided in downward direction D10 from coil conductor 11a. Coil conductor 13a is provided in downward direction D10 from coil conductor 12a. Coil conductor 11b is provided in downward direction D10 from coil conductor 13a. Coil conductor 12b is provided in downward direction D10 from coil conductor 11b. Coil conductor 13b is provided in downward direction D10 from coil conductor 12b.

In downward direction D10, between two coil conductors constituting one of the three coils, one of two coil conductors constituting one of the other two coils and one of two coil conductors constituting another of the other two coils are located. In other words, in downward direction D10, coil conductor 12a constituting coil 12 and coil conductor 13a constituting coil 13 are located between coil conductors 11a and 11b constituting coil 11. In downward direction D10, coil conductor 11b constituting coil 11 and coil conductor 13b constituting coil 13 are located between coil conductors 12a and 12b constituting coil 12. In downward direction D10, coil conductor 11b constituting coil 11 and coil conductor 12b constituting coil 12 are located between coil conductors 13a and 13b constituting coil 13.

Coil 11 is magnetically coupled to coil 12. Coil 12 is magnetically coupled to coil 13. Coil 11 is magnetically coupled to coil 13.

In common mode noise filter 1001, coil conductors 11a and 13a and coil conductors 11b and 13b deviate in direction D11 perpendicular to downward direction D10 with respect to coil conductors 12a and 12b viewing from above. In other words, coil conductors 11a and 13a constituting coils 11 and 13 deviate in direction D11 with respect to coil conductor 12a constituting coil 12 viewing from above. Coil conductors 11b and 13b constituting coils 11 and 13 deviate in direction D11 with respect to coil conductor 12b constituting coil 12 viewing from above.

Coil conductors 11a to 13a and 11b to 13b have spiral shapes wound about coil axis C11. The state in which spirally wound coil conductors 11a, 13a, 11b, and 13b deviate in direction D11 with respect to coil conductors 12a and 12b means that, in any cross-section of laminated body 15 parallel with downward direction D10, portions of coil conductors 11a, 13a, 11b, and 13b at a certain number of turn counted from respective inner circumferences 111a, 113a, 111b, and 113b toward respective outer circumferences 211a, 213a, 211b, and 213b deviate in downward direction D11 with respect to portions of coil conductors 12a and 12b at the certain number of turn counted from respective inner circumferences 112a and 112b toward respective outer circumferences 212a and 212b viewing from above. Specifically, in any cross-section of laminated body 15 parallel with downward direction D10, a portion of coil conductor 12a at a certain number of turn counted from inner circumference 112a toward outer circumference 212a deviates toward coil axis C11 in direction D11 with respect to a cross-section at portions of coil conductors 11a and 13a at the certain number of turn counted from respective inner circumferences 111a and 113a toward respective outer circumferences 211a and 213a viewing from above. In any cross-section of laminated body 15 parallel with downward direction D10, portions of coil conductor 11b and 13b at a certain number of turn counted from respective inner circumferences 111b and 113b toward respective outer circumferences 211b and 213b deviate toward coil axis C11 in direction D11 with respect to a portion of coil conductor 12b at the certain number of turn counted from inner circumference 112b toward outer circumference 212b viewing from above.

Coil conductors 11a and 13a are disposed substantially at the same position viewing from above to face each other in downward direction D10. Coil conductors 11b and 13b are disposed substantially at the same position viewing from above to face each other. A portion of coil conductor 11a having the spiral shape constituting coil 11 overlaps a portion of coil conductor 13a having the spiral shape constituting coil 13 viewing from above. A portion of coil conductor 11b having the spiral shape constituting coil 11 overlaps a portion of coil conductor 13b having the spiral shape constituting coil 13 viewing from above.

In common mode noise filter 1001 illustrated in FIG. 1, FIG. 2A, and FIG. 2B, coil conductors 11a and 13a completely overlap each other viewing from above, and coil conductors 11b and 13b completely overlap each other viewing from above. Coil conductors 11a and 13a may partially overlap each other viewing from above, and coil conductors 11b and 13b may partially overlap each other viewing from above.

In common mode noise filter 1001, the same number of coil conductors are located at the same position viewing from above. This configuration allows stresses applied at the time of lamination to be preferably uniform. The locations of coil conductors 11b and 13b viewing from above may be replaced with the location of coil conductor 12b viewing from above.

A part of coil conductor 11a constituting coil 11 and a part of coil conductor 13a constituting coil 13 overlap coil conductor 12a constituting coil 12 viewing from direction D11. Apart of coil conductor 11b constituting coil 11 and a part of coil conductor 13b constituting coil 13 overlap coil conductor 12b constituting coil 12 viewing from direction D11. In other words, coil conductor 11a constituting coil 11 and coil conductor 13a constituting coil 13 partially overlap coil conductor 12a constituting coil 12 viewing from direction D11. In addition, coil conductor 11b constituting coil 11 and coil conductor 13b constituting coil 13 partially overlap coil conductor 12b constituting coil 12 viewing from direction D11.

Non-magnetic body 14 has coil conductors 11a, 11b, 12a, 12b, 13a, and 13b built therein and includes plural non-magnetic layers stacked on one another. These non-magnetic layers are made of non-magnetic material, such as Cu—Zn ferrite or glass ceramics, having sheet shapes.

Coil conductors 11a, 11b, 12a, 12b, 13a, and 13b are formed by, for example, vapor-depositing on, plating, or printing the non-magnetic layers with conductive material, such as metal.

Magnetic bodies 17a and 17b made of magnetic material, such as Ni—Cu—Zn ferrite, are provided above and below non-magnetic body 14, respectively. Common mode noise filter 1001 does not necessarily include magnetic bodies 17a and 17b. Each of magnetic bodies 17a and 17b may include plural non-magnetic layers and plural magnetic layers that are alternately stacked.

Laminated body 18 has the above-described configuration. Six outer electrodes connected to respective ends of coil conductors 11a, 11b, 12a, 12b, 13a, and 13b are provided on both end surfaces of laminated body 18.

As described above, in common mode noise filter 1001 according to Embodiment 1, a part of coil 11 is adjacent to a part of coil 12 viewing from direction D11. Apart of coil 12 is adjacent to a part of coil 13 viewing from direction D11. Coil 11 is adjacent to coil 13 in downward direction D10 (up-and-down direction). Therefore, coils 11, 12, and 13 are magnetically coupled to each other with a preferable balance. In other words, coils 11 and 12 are magnetically coupled to each other, coils 12 and 13 are magnetically coupled to each other at the same level of strength as that of magnetic coupling between coils 11 and 12. Coils 11 and 13 are magnetically coupled to each other at the same level of strength as that of magnetic coupling between coils 11 and 12 and that of magnetic coupling between coils 12 and 13. This configuration prevents degradation of differentials signal input to coils 11 to 13.

A part of coil 11 and a part of coil 13 overlap coil 12 viewing from direction D11. This configuration reduces the height of common mode noise filter 1001.

In common mode noise filter 1001 according to Embodiment 1, each coil includes two coil conductors that are electrically connected to each other. In the common mode noise filter according to Embodiment 1, even in the case where each coil includes three or more coil conductors that are electrically connected to each other, the same effect is achieved. Alternatively, even in the case where each coil includes a single coil conductor, the same effect is achieved.

FIG. 3 is an enlarged cross-sectional view of common mode noise filter 1001 according to Embodiment 1, and illustrates a cross-section of common mode noise filter 1001 parallel with downward direction D10. FIG. 3 illustrates portion 412a of coil conductor 12a of coil 12 at the N-th turn from inner circumference 112a of coil conductor 12a, portion 312a of coil conductor 12a of coil 12 at the (N-1)-th turn from inner circumference 112a of coil conductor 12a, portion 411a of coil conductor 11a of coil 11 at the N-th turn from inner circumference 111a of coil conductor 11a, portion 311a of coil conductor 11a of coil 11 at the (N-1)-th turn from inner circumference 111a of coil conductor 11a, portion 413a of coil conductor 13a of coil 13 the N-th turn from inner circumference 113a of coil conductor 13a, and portion 313a of coil conductor 13a of coil 11 at the (N-1)-th turn from inner circumference 113a of coil conductor 13a of coil 11 at a cross-section of common mode noise filter 1001 parallel with downward direction D10 (N is a number satisfying 1≤N≤M).

Distance La between portion 411a of coil conductor 11a and portion 413a of coil conductor 13a, distance Lb between portion 411a of coil conductor 11a and portion 412a of coil conductor 12a, and distance Lc between portion 412a of coil conductor 12a and portion 413a of coil conductor 13a are substantially identical to one another. Each of portions 411a, 412a, and 413a of coil conductors 11a, 12a, and 13a constitutes corresponding one of the apexes of a regular triangle. Each of portions 311a, 312a, and 313a of coil conductors 11a, 12a, and 13a constitutes a corresponding one of the apexes of a regular triangle.

In other words, line PLa that connects coil conductor 11a and coil conductor 13a, line PLb that connects coil conductor 11a and coil conductor 12a, and line PLc that connects coil conductor 12a and coil conductor 13a form a regular triangle.

The distances between any two of coils 11, 12, and 13 are substantially identical to each other. Then, the balance of magnetic coupling can be further improved.

Distance Ld between portion 412a of coil conductor 12a at the N-th turn and portion 311a of coil conductor 11a at the (N-1)-th turn, and distance Le between portion 412a of coil conductor 12a at the N-th turn and portion 313a of coil conductor 13a at the (N-1)-th turn are substantially identical to distances La, Lb, and Lc.

A method for manufacturing coil conductors 11a, 12a, and 13a of common mode noise filter 1001 according to Embodiment 1 will be described below with reference to FIG. 3.

First, portion 13a1 of coil conductor 13a is formed on the upper surface of non-magnetic layer 14a.

Next, non-magnetic layer 14b is formed around portion 13a1 of coil conductor 13a on the upper surface of non-magnetic layer 14a.

Next, portion 13a2 of coil conductor 13a is formed on the upper surface of portion 13a1 of coil conductor 13a. Portion 12a1 of coil conductor 12a is formed on the upper surface of non-magnetic layer 14b. Then, non-magnetic layer 14c is formed around portions 12a1 and 13a2 of respective coil conductors 12a and 13a on the upper surface of non-magnetic layer 14b.

Next, portion 12a2 of coil conductor 12a is formed on the upper surface of portion 12a1 of coil conductor 12a. Then, non-magnetic layer 14d is formed around portion 12a2 of coil conductor 12a on the upper surface of non-magnetic layer 14c.

Next, remaining portion 12a3 of coil conductor 12a is formed on the upper surface of portion 12a2 of coil conductor 12a, and portion 11a1 of coil conductor 11a is formed on the upper surface of non-magnetic layer 14d. Then, non-magnetic layer 14e is formed around portions 11a1 and 12a3 of respective coil conductors 11a and 12a on the upper surface of non-magnetic layer 14d.

Next, remaining portion 11a2 of coil conductor 11a is formed on the upper surface of portion 11a1 of coil conductor 11a. Then, non-magnetic layer 14f is formed around portion 11a2 of coil conductor 11a on the upper surface of non-magnetic layer 14e.

Coil conductors 11b, 12b, and 13b are formed similarly to coil conductors 11a, 12a, and 13a.

Coil conductors 11a, 11b, 12a, 12b, 13a, and 13b may be formed by any one of sputtering (thin film sputtering), plating (transfer plating), and printing, or a combination thereof.

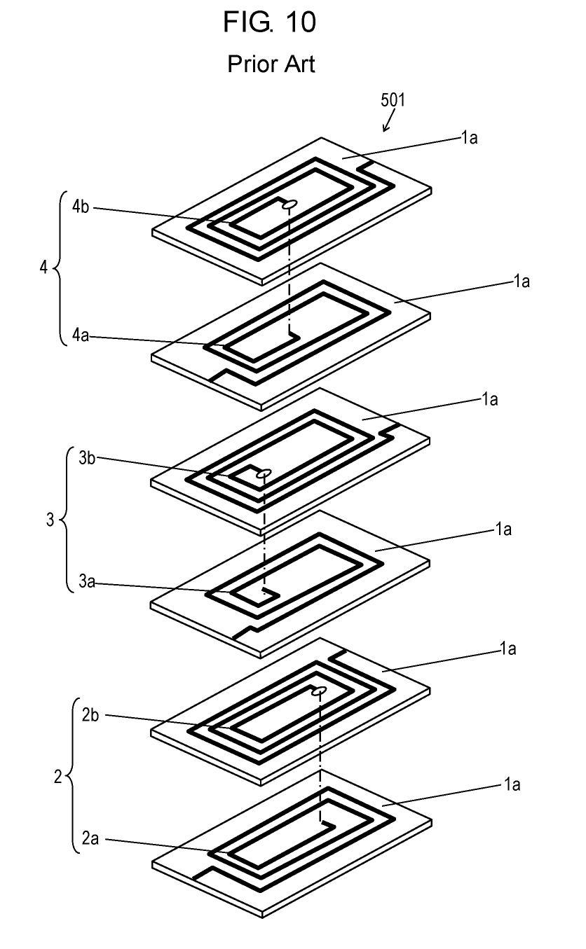

In conventional common mode noise filter 501 illustrated in FIG. 10, coil 3 is disposed between coils 2 and 4, and accordingly, the distance between coils 2 and 4 is longer. Such distance causes coil 2 to be hardly magnetically coupled to coil 4.

In the case that common mode noise filter 501 is applied to a three-wire differential signal line, when differential data signals are transmitted with the signal line, magnetic fluxes generated in coils 2 and 4 that are not magnetically coupled to each other produces a large residual inductance without canceling each other out. This configuration increases a loss in the differential data signals and significant degradation in differential signal quality

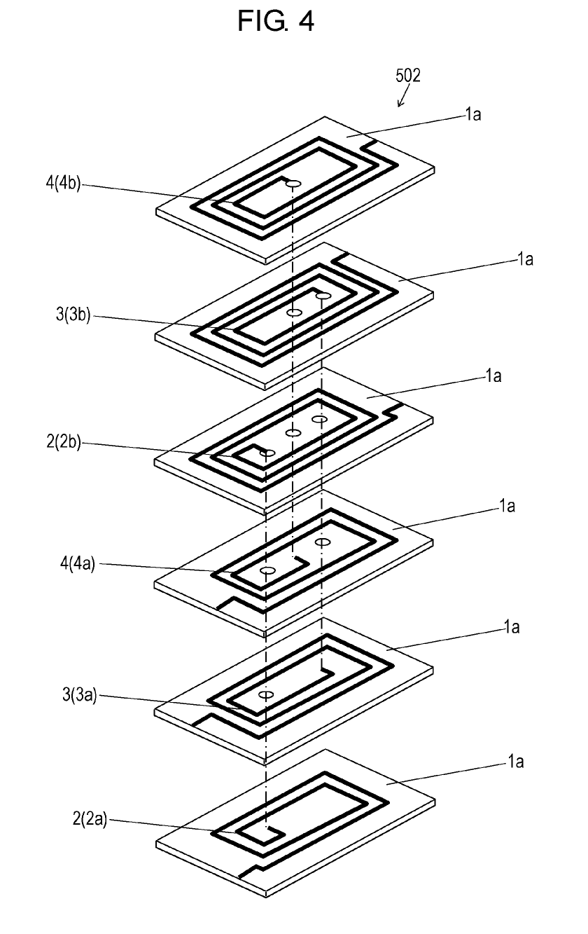

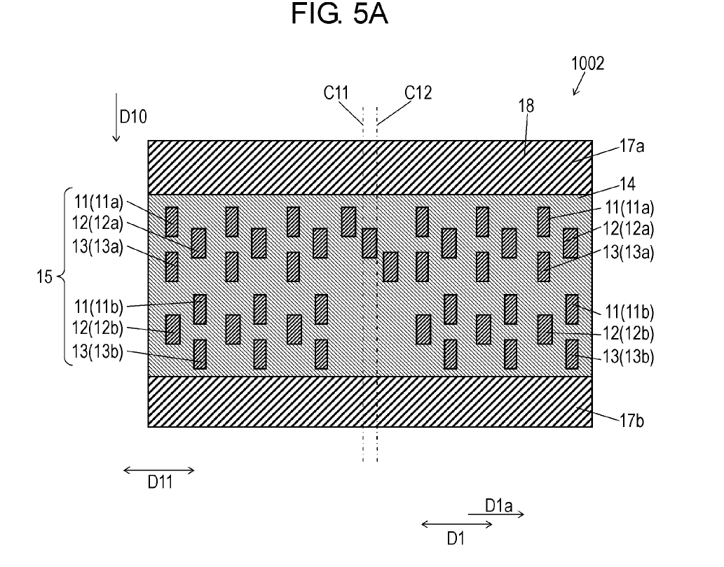

FIG. 4 is an exploded perspective view of a comparative example of common mode noise filter 502. In FIG. 4, components identical to those of common mode noise filter 501 illustrated in FIG. 10 are dented by the same reference numerals. In common mode noise filter 502 illustrated in FIG. 4, coil conductor 2a constituting coil 2, coil conductor 3a constituting coil 3, coil conductor 4a constituting coil 4, coil conductor 2b constituting coil 2, coil conductor 3b constituting coil 3, and coil conductor 4b constituting coil 4 are stacked in this order. Coils 2 and 3 are adjacent to each other at two locations, and coils 3 and 4 are adjacent to each other at two locations. This configuration enhances the magnetic coupling.

However, in the comparative example of common mode noise filter 502, coils 2 and 4 sandwich coil 3, and are accordingly more distant from each other. Thus, magnetic coupling between coils 2 and 4 is weaker than magnetic coupling between coils 2 and 3 and magnetic coupling between coils 3 and 4. Therefore, coils 2, 3, and 4 are magnetically coupled to each other with a poor balance. When differential signals are input to common mode noise filter 502 illustrated in FIG. 4, degradation of the differential signal is small in coil 3 since coil 3 is magnetically coupled to coils 2 and 4 adjacent to coil 3. However, in common mode noise filter 502, the distance between coil conductors 2b and 4b and the distance between coil conductors 2a and 4a are large, and accordingly, magnetic coupling between coil conductors 2b and 4b is weak and magnetic coupling between coil conductors 2a and 4a is weak. Therefore, the differential signals passing through coils 2 and 4 are degraded.

As described above, common mode noise filter 1001 according to Embodiment 1 prevents degradation of differential signals input to coils 11 to 13.

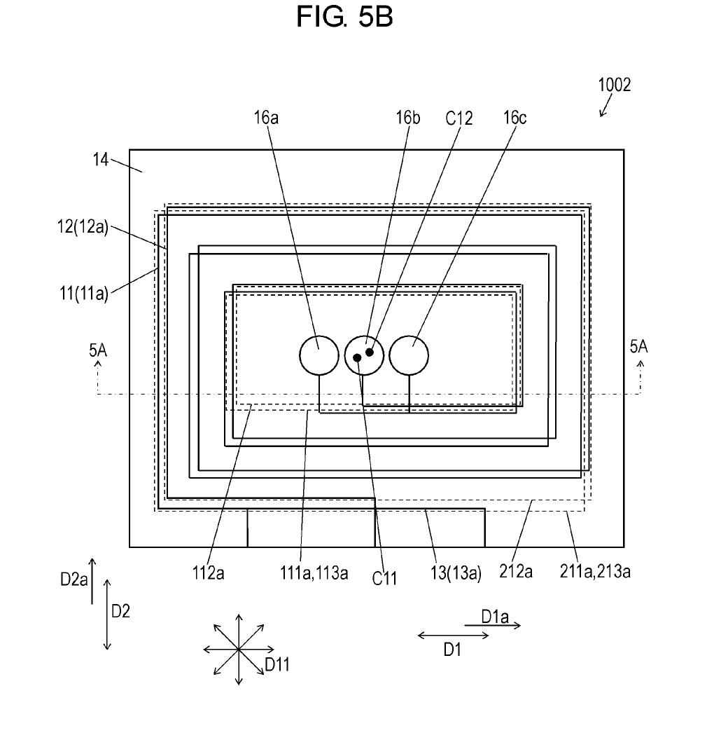

FIG. 5A is a cross-sectional view of another common mode noise filter 1002 according to Embodiment 1. FIG. 5B is a top view of common mode noise filter 1002. FIG. 5A illustrates a cross section of common mode noise filter 1002 along line 5A-5A shown in FIG. 5B. In FIG. 5A and FIG. 5B, components identical to those of common mode noise filter 1001 illustrated in FIG. 1 to FIG. 3 are denoted by the same reference numerals. In common mode noise filter 1002, coil conductors 11a, 12b, and 13a have spiral shapes wound about coil axis C11, and coil conductors 11b, 12a, and 13b have spiral shapes wound about coil axis C12. Coil axis C12 deviates with respect to coil axis C11 in a diagonal direction of the rectangular shape of the coil conductors, that is, in both of longitudinal direction D1 and lateral direction D2 of the rectangular shape. Coil conductor 11a overlaps coil conductor 13a viewing from above, and coil conductor 11b overlaps coil conductor 13b viewing from above. A portion of coil conductor 12a extending slenderly in longitudinal direction D1 deviates in direction D2a parallel to lateral direction D2 with respect to a portion of coil conductor 11a (13a) extending slenderly in longitudinal direction D1. A portion of coil conductor 12a extending slenderly in lateral direction D2 deviates in direction D1a parallel to longitudinal direction D1 with respect to the portion of coil conductor 11a (13a)extending slenderly in lateral direction D2. Common mode noise filter 1002 provides the same effect as common mode noise filter 1001.

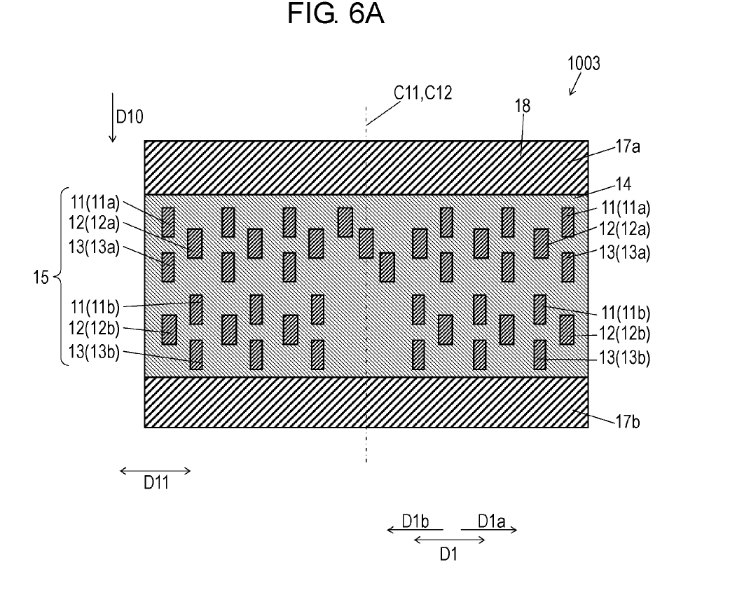

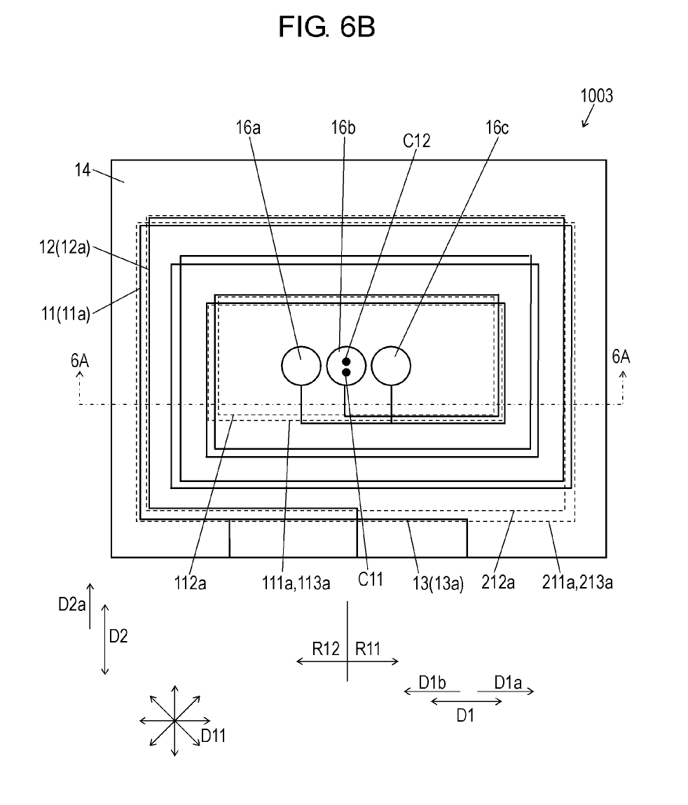

FIG. 6A is a cross-sectional view of still another common mode noise filter 1003 according to Embodiment 1. FIG. 6B is a top view of common mode noise filter 1003. FIG. 6A illustrates a cross section of common mode noise filter 1002 along line 6A-6A shown in FIG. 6B. In FIG. 6A and FIG. 6B, components identical to those of components of common mode noise filter 1002 illustrated in FIG. 5A and FIG. 5B are denoted by the same reference numerals. In common mode noise filter 1003, coil conductors 11a, 12b, and 13a have spiral shapes wound about coil axis C11, and coil conductors 11b, 12a, and 13b have spiral shapes wound about coil axis C12. Coil axis C12 deviates in direction D2a parallel to lateral direction D2, but does not deviate in longitudinal direction D1 with respect to coil axis C11. Specifically, coil conductors 11a and 13a overlap each other viewing from above, and coil conductors 11b and 13b overlap each other viewing from above. A portion of coil conductor 12a extending slenderly in longitudinal direction D1 deviates in direction D2a parallel to lateral direction D2 with respect to a portion of coil conductor 11a (13a) extending slenderly in longitudinal direction D1. A portion of coil conductor 12a extending slenderly in lateral direction D2 deviates in a direction parallel to longitudinal direction D1 with respect to a portion of coil conductor 11a (13a) extending slenderly in lateral direction D2. Specifically, the portion of coil conductor 12a extending slenderly in lateral direction D2 includes a portion located in region R11 located in longitudinal direction D1 with respect to coil axes C11 and C12, and a portion located in region R12 opposite to region R11 in longitudinal direction D1 with respect to coil axes C11 and C12. The portion of coil conductor 12a extending slenderly in lateral direction D2 and being located in region R11 deviates in direction D1b parallel to longitudinal direction D1 with respect to the portion of coil conductor 11a (13a) extending slenderly in lateral direction D2 and being located in region R11. The portion of coil conductor 12a extending slenderly in lateral direction D2 and located in region R12 deviates in direction D1a parallel to longitudinal direction D1 and opposite to direction D1b with respect to the portion of coil conductor 11a (13a) extending slendlerly in lateral direction D2 and being located in region R12. Common mode noise filter 1003 provides the same effect as common mode noise filters 1001 and 1002.

Coil axis C12 of coil conductors 11b, 12a, and 13b deviates in longitudinal direction D1 with respect to coil axis C11 of coil conductors 11a, 12b, and 13a, but may not deviate in lateral direction D2 with respect to coil axis C11, providing same effect.

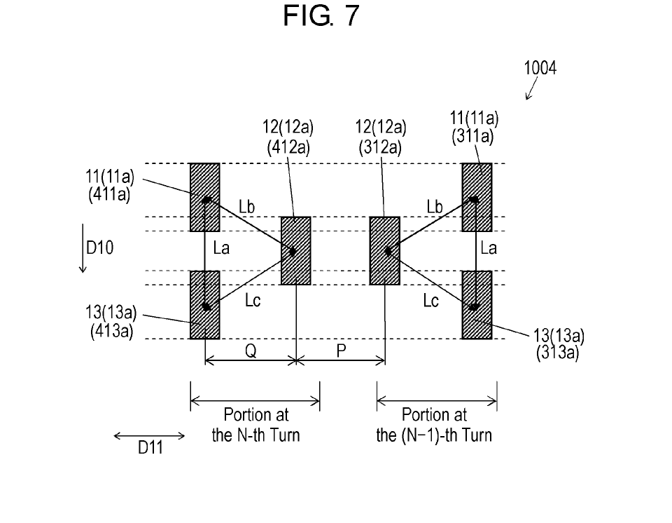

FIG. 7 is an enlarged cross-sectional view of further common mode noise filter 1004 according to Embodiment 1. In FIG. 7, components identical to those of common mode noise filter 1001 illustrated in FIG. 1 to FIG. 3 are denoted by the same reference numerals. In common mode noise filter 1004 illustrated in FIG. 7, viewing from above, portion 412a of coil conductor 12a at the N-th turn and portion 312a of coil conductor 12a at the (N-1)-th turn are located between portion 411a of coil conductor 11a at the N-th turn and portion 311a of coil conductor 11a at the (N-1)-th turn and located between portion 413a of coil conductor 13a at the N-th turn and portion 313a of coil conductor 13a at the (N-1)-th turn. Portions 312a and 412a of coil conductor 12a are adjacent to each other and have the same electric potential, and accordingly, distance P between portions 312a and 412a of coil conductor 12a can be reduced. This configuration can increase the number of turns of each of coils 11, 12, and 13. Viewing from above, distance Q between portion 412a of coil conductor 12a and each of portions 411a and 413a of coil conductors 11a and 13a, in other words, between portion 312a of coil conductor 12a and each of portions 311a and 313a of respective coil conductors 11a and 13a is larger than distance P.

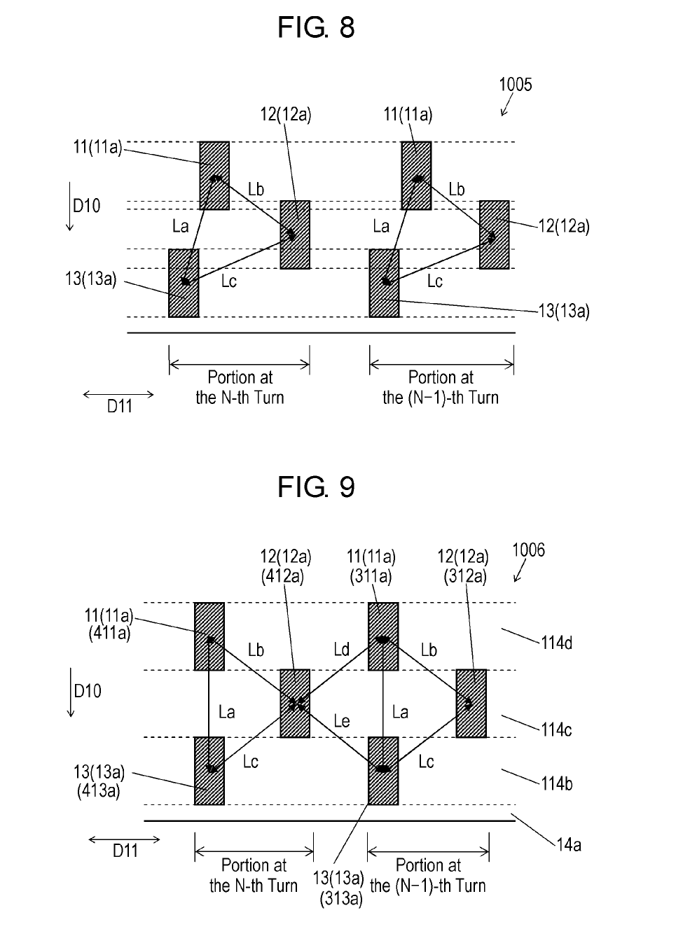

FIG. 8 is an enlarged cross-sectional view of further common mode noise filter 1005 according to Embodiment 1. In FIG. 8, components identical to those of common mode noise filter 1001 illustrated in FIG. 1 to FIG. 3 are denoted by the same reference numerals. In common mode noise filter 1005 illustrated in FIG. 8, coil conductors 11a, 12a, and 13a do not overlap one another viewing from above. Coil conductors 11b, 12b, and 13b do not overlap one another viewing from above.

In common mode noise filter 1001 illustrated in FIG. 1 to FIG. 3, the capacitance between coil conductors 11a and 13a facing each other and overlapping viewing from above is larger than the capacitance between coil conductors 11a and 12a facing each other in a smaller area and the capacitance between coil conductors 12a and 13a facing each other in a smaller area. In common mode noise filter 1005 illustrated in FIG. 8, coil conductor 11a does not overlap coil conductor 13a viewing from above, hence reducing the capacitance between coil conductors 11a and 13a. This configuration allows, in common mode noise filter 1005, the capacitances between coil conductors 11a, 12a, and 13a to be well-balanced, thereby preventing degradation of differential signals input to common mode noise filter 1005.

### Exemplary Embodiment 2

FIG. 9 is an enlarged cross-sectional view of common mode noise filter 1006 according to Exemplary Embodiment 2. In FIG. 9, components identical to those of common mode noise filter 1001 illustrated in FIG. 1 to FIG. 3 are denoted by the same reference numerals.

In common mode noise filter 1006 according to Embodiment 2 illustrated in FIG. 9, unlike in common mode noise filter 1001 according to Embodiment 1, coil conductor 11a constituting coil 11, coil conductor 12a constituting coil 12, and coil conductor 13a constituting coil 13 do not overlap each other viewing from direction D11 perpendicular to downward direction D10. Furthermore, the upper surface of coil conductor 12a is flush with the lower surface of coil conductor 11a. The lower surface of coil conductor 12a is flush with the upper surface of coil conductor 13a.

Similarly to common mode noise filter 1001 according to Embodiment 1, in common mode noise filter 1006, distances La, Lb, and Lc are substantially identical to one another. Each of portions 411a, 412a, and 413a of coil conductors 11a, 12a, and 13a constitutes a corresponding one of the apexes of a regular triangle. Each of portions 311a, 312a, and 313a of coil conductors 11a, 12a, and 13a constitutes a corresponding one of the apexes of a regular triangle.

In common mode noise filter 1006, each coil conductor overlaps only one non-magnetic layer in direction D11, and hence, it is not necessary to form one coil conductor with plural processes. Therefore, common mode noise filter 1006 can be more easily manufactured than common mode noise filter 1001 according to Embodiment 1.

Viewing from direction D11, any other non-magnetic layer is not provided between the upper surface of coil conductor 12a and the lower surface of coil conductor 11a, and any other non-magnetic layer is not provided between the lower surface of coil conductor 12a and the upper surface of coil conductor 13a. This configuration allows coil conductors 11a to 13 to be strongly magnetically coupled to each other.

The size and arrangement of the coil conductors are adjusted so that any two of three coil conductor portions at the same number of turn are magnetically coupled at approximately the same strength level.

In common mode noise filter 1006, coil conductors 11a to 13a may be disposed similarly to common mode noise filter 1004 according to Embodiment 1 illustrated in FIG. 7. Alternatively, in common mode noise filter 1006, coil conductors 11a to 13a may be disposed similarly to common mode noise filter 1005 according to Embodiment 1 illustrated in FIG. 8.

The above-described enlarged cross-sectional views shown in FIG. 3 and FIG. 7 to FIG. 9 illustrate coil conductors 11a, 11b, and 11c constituting respective coils 11, 12, and 13, but coil conductors 11b, 12b, and 13b constituting respective coils 11, 12, and 13 may be disposed in the same manner as above.

In Embodiments, terms, such as “upper surface”, “lower surface”, “downward”, and “viewing from above”, indicating directions indicate relative directions depending only on the relative positional relationship between components, such as coil conductors, of a common mode noise filter, and do not indicate absolute directions, such as a vertical direction.

### REFERENCE MARKS IN THE DRAWINGS

11 coil
11a coil conductor (first coil conductor)
11b coil conductor
12 coil
12a coil conductor (second coil conductor)
12b coil conductor
13 coil
13a coil conductor (third coil conductor)
13b coil conductor
14 non-magnetic body
15 laminated body

1. A common mode noise filter comprising:
a non-magnetic body;
a first coil conductor provided inside the non-magnetic body and having a spiral shape with one or more turns;
a second coil conductor provided inside the non-magnetic body and in a downward direction from the first coil conductor, the second coil conductor having a spiral shape with one or more turns that extends in parallel with the spiral shape of the first coil conductor to be magnetically coupled to the first coil conductor; and
a third coil conductor provided inside the non-magnetic body and in the downward direction from the second coil conductor, the third coil conductor having a spiral shape with one or more turns that extends in parallel with the spiral shape of the first coil conductor and the spiral shape of the second coil conductor to be magnetically coupled to the first coil conductor and the second coil conductor,
wherein the first coil conductor and the third coil conductor deviate in a direction perpendicular to the downward direction with respect to the second coil conductor, and
wherein at least one of the first coil conductor and the third coil conductor overlaps with the second coil conductor viewing from the direction perpendicular to the downward direction.

2. The common mode noise filter according to claim 1, wherein a part of the first coil conductor and a part of the third coil conductor overlap the second coil conductor viewing from the direction perpendicular to the downward direction.

3. The common mode noise filter according to claim 1,
wherein the spiral shape of the first coil conductor has M turns from a first inner circumference of the first coil conductor to a first outer circumference of the first coil conductor, where M is a number equal to or greater than one,
wherein the spiral shape of the second coil conductor has M turns from a second inner circumference of the second coil conductor to a second outer circumference of the second coil conductor,
wherein the spiral shape of the third coil conductor has M turns from a third inner circumference of the third coil conductor to a third outer circumference of the third coil conductor, and
wherein, in a cross-section parallel to the downward direction, each of a portion of the first coil conductor at an N-th turn from the first inner circumference of the first coil conductor, a portion of the second coil conductor at an N-th turn from the second inner circumference of the second coil conductor, and a portion of the third coil conductor at an N-th turn from the third inner circumference of the third coil conductor constitutes respective one of apexes of a regular triangle, where N is a number satisfying 1≤N≤M.

4. The common mode noise filter according to claim 1,
wherein the spiral shape of the first coil conductor has M turns from a first inner circumference of the first coil conductor to a first outer circumference of the first coil conductor, where M is a number equal to or greater than one,
wherein the spiral shape of the second coil conductor has M turns from a second inner circumference of the second coil conductor to a second outer circumference of the second coil conductor,
wherein the spiral shape of the third coil conductor has M turns from a third inner circumference of the third coil conductor to a third outer circumference of the third coil conductor, and
wherein, in a cross-section parallel with the downward direction, a portion of the second coil conductor at an N-th turn from the second inner circumference of the second coil conductor and a portion of the second coil conductor at an (N-1)-th turn from the second inner circumference of the second coil conductor are located between a portion of the first coil conductor at an N-th turn from the first inner circumference of the first coil conductor and a portion of the first coil conductor at an (N-1)-th turn from the first inner circumference of the first coil conductor, and are located between a portion of the third coil conductor at an N-th turn from the third inner circumference of the third coil conductor and a portion of the third coil conductor at an (N-1)-th turn from the third inner circumference of the third coil conductor, where N is a number satisfying 1≤N≤M).

5. The common mode noise filter according to claim 1, wherein the first coil conductor, the second coil conductor, and the third coil conductor do not overlap each other viewing from above.

6. The common mode noise filter according to claim 1, wherein the spiral shape of the first coil conductor, the spiral shape of the second coil conductor, and the spiral shape of the third coil conductor are identical to each other.

7. A common mode noise filter comprising:
a non-magnetic body;
a first coil conductor provided inside the non-magnetic body and having a spiral shape with one or more turns;
a second coil conductor provided inside the non-magnetic body and in a downward direction from the first coil conductor, the second coil conductor having a spiral shape with one or more turns that extends in parallel with the spiral shape of the first coil conductor to be magnetically coupled to the first coil conductor; and
a third coil conductor provided inside the non-magnetic body and in the downward direction from the second coil conductor, the third coil conductor having a spiral shape with one or more turns that extends in parallel with the spiral shape of the first coil conductor and the spiral shape of the second coil conductor to be magnetically coupled to the first coil conductor and the second coil conductor,
wherein the first coil conductor and the third coil conductor deviate in a direction perpendicular to the downward direction with respect to the second coil conductor,
wherein the first coil conductor, the second coil conductor, and the third coil conductor do not overlap each other viewing from the direction perpendicular to the downward direction,
wherein an upper surface of the second coil conductor is flush with a lower surface of the first coil conductor, and
wherein a lower surface of the second coil conductor is flush with an upper surface of the third coil conductor.

8. The common mode noise filter according to claim 7,
wherein the spiral shape of the first coil conductor has M turns from a first inner circumference of the first coil conductor to a first outer circumference of the first coil conductor, where M is a number equal to or greater than one,
wherein the spiral shape of the second coil conductor has M turns from a second inner circumference of the second coil conductor to a second outer circumference of the second coil conductor,
wherein the spiral shape of the third coil conductor has M turns from a third inner circumference of the third coil conductor to a third outer circumference of the third coil conductor, and
wherein, in a cross-section parallel with the downward direction, each of a portion of the first coil conductor at an N-th turn from the first inner circumference of the first coil conductor, a portion of the second coil conductor at an N-th turn from the second inner circumference of the second coil conductor, and a portion of the third coil conductor at the Nth turn from the third inner circumference of the third coil conductor constitutes respective one of apexes of a regular triangle, where N is a number satisfying 1≤N≤M).

9. The common mode noise filter according to claim 7,
wherein the spiral shape of the first coil conductor has M turns from a first inner circumference of the first coil conductor to a first outer circumference of the first coil conductor, where M is a number equal to or greater than one,
wherein the spiral shape of the second coil conductor has M turns from a second inner circumference of the second coil conductor to a second outer circumference of the second coil conductor,
wherein the spiral shape of the third coil conductor has M turns from a third inner circumference of the third coil conductor to a third outer circumference of the third coil conductor, and
wherein, in a cross-section parallel with the downward direction, a portion of the second coil conductor at an N-th turn from the second inner circumference of the second coil conductor and a portion of the second coil conductor at an (N-1)-th turn from the second inner circumference of the second coil conductor are located between a portion of first inner circumference at an N-th turn from the first inner circumference of the first coil conductor and a portion of the first inner circumference at an (N-1)-th turn from the first inner circumference of the first coil conductor, and are located between a portion of the third coil conductor at an N-th turn from the third inner circumference of the third coil conductor and a portion of the third coil conductor at an (N-1)-th turn from the third inner circumference of the third coil conductor, wherein N is a number satisfying 1≤N≤M).

10. The common mode noise filter according to claim 7, wherein the first coil conductor, the second coil conductor, and the third coil conductor do not overlap each other viewing from above.

11. The common mode noise filter according to claim 7, wherein the spiral shape of the first coil conductor, the spiral shape of the second coil conductor, and the spiral shape of the third coil conductor are identical to each other.
